(19) United States
(12) Patent Application Publication
(10) Pub. No.: US 2026/0313689 A1
(43) Pub. Date: Oct. 8, 2026

(54) METHOD OF COORDINATED OPERATION IN WLAN AND ACCESS POINT DEVICE

(71) Applicant: GUANGDONG OPPO MOBILE TELECOMMUNICATIONS CORP., LTD., Dongguan (CN)

(72) Inventor: Dong Wei, Dongguan (CN)

(21) Appl. No.: 19/572,453

(22) Filed: Mar. 19, 2026

Related U.S. Application Data
(60) Provisional application No. 63/782,192, filed on Apr. 2, 2025.
(60) Provisional application No. 63/783,549, filed on Apr. 4, 2025.
(60) Provisional application No. 63/785,828, filed on Apr. 9, 2025.
(60) Provisional application No. 63/786,566, filed on Apr. 10, 2025.

(51) Int. Cl. H04W 74/0816; H04B 7/06; H04L 1/00; H04W 64/00; H04W 74/04; H04W 84/12

(52) U.S. Cl. CPC H04W 74/0816; H04B 7/0626; H04L 1/0003; H04W 64/00; H04W 74/04; H04W 84/12

(57) ABSTRACT

A method of coordinated operation performed by an access point (AP) device in a wireless local area network (WLAN) includes transmitting, to at least one other AP device, coordination information or a negotiation request frame for multi-AP coordination (MAPC), and performing, based on a response from the at least one other AP device, a coordinated operation, wherein the coordinated operation includes at least one of coordinated beamforming (Co-BF), coordinated spatial reuse (Co-SR), coordinated time-division multiple access (Co-TDMA), or coordinated ranging and positioning.

### CROSS REFERENCE TO RELATED APPLICATIONS

This application claims priority to U.S. Provisional Application No. 63/782,192, entitled “METHOD AND APPARATUS FOR COORDINATED POSITIONING WITH MULTIPLE ACCESS POINTS IN WIRELESS LOCAL AREA NETWORKS,” filed on Apr. 2, 2025; U.S. Provisional Application No. 63/783,549, entitled “METHOD AND APPARATUS FOR COORDINATION BEAMFORMING AND COORDINATED SPATIAL REUSE IN WIRELESS LOCAL AREA NETWORKS USING A UNIFIED FRAMEWORK,” filed on Apr. 4, 2025; U.S. Provisional Application No. 63/785,828, entitled “METHOD AND APPARATUS FOR COORDINATION AMONG MULTIPLE ACCESS POINTS USING TARGET WAKE TIME IN WIRELESS LOCAL AREA NETWORKS,” filed on Apr. 9, 2025; and U.S. Provisional Application No. 63/786,566, entitled “METHOD AND APPARATUS FOR DATE TRANSMISSION PROCEDURE OF COORDINATION BEAMFORMING IN WIRELESS LOCAL AREA NETWORKS,” filed on Apr. 10, 2025; each of which is hereby incorporated in its entirety by reference.

### TECHNICAL FIELD

The present disclosure relates to the field of communication systems, and more particularly, to a method of coordinated operation performed by an access point (AP) device in a wireless local area network (WLAN) and an AP device.

### BACKGROUND

In wireless local area networks (WLANs), access point (AP) devices may operate with different channel bandwidths and transmission configurations. However, existing coordinated beamforming (Co-BF) techniques typically assume equal bandwidth operation among AP devices and rely on duplicated channel sounding procedures, which leads to inefficient use of airtime. In addition, current coordinated spatial reuse (Co-SR) schemes often require additional measurement functionality and introduce extra signaling overhead. Existing multi-AP coordination (MAPC) mechanisms further lack comprehensive procedures for negotiation, fairness handling, and coordination termination. Moreover, channel sounding and data transmission sequences in current MAPC solutions are fragile, such that failure to receive an expected response from an AP device or a station may cause an entire coordinated operation to fail.

Therefore, there is a need for apparatuses and methods of coordinated operation.

### SUMMARY

An object of the present disclosure is to propose a method of coordinated operation performed by an access point (AP) device in a wireless local area network (WLAN) and related apparatus, which can solve issues in the prior art and other issues, provide unequal-bandwidth operation, low-overhead unified sounding, opportunistic path-loss measurement, TWT-assisted station availability, per-spatial-stream unequal modulation, failure-resilient procedures, and/or improved efficiency, flexibility, and reliability in wireless local area networks.

In a first aspect of the present disclosure, a method of coordinated operation performed by an access point (AP) device in a wireless local area network (WLAN) includes transmitting, to at least one other AP device, coordination information or a negotiation request frame for multi-AP coordination (MAPC); and performing, based on a response from the at least one other AP device, a coordinated operation, wherein the coordinated operation includes at least one of: a coordinated beamforming (Co-BF), a coordinated spatial reuse (Co-SR), a coordinated time-division multiple access (Co-TDMA), or a coordinated ranging and positioning.

In a second aspect of the present disclosure, a method of coordinated operation performed by an access point (AP) device includes receiving, from another AP device, coordination information or a negotiation request frame for multi-AP coordination (MAPC); and transmitting, to the another AP device, a response indicating acceptance, rejection, or configuration information for a coordinated operation including at least one of: a coordinated beamforming (Co-BF), a coordinated spatial reuse (Co-SR), a coordinated time-division multiple access (Co-TDMA), or a coordinated ranging and positioning.

In a third aspect of the present disclosure, an AP device includes a memory, a transceiver, and a processor coupled to the memory and the transceiver. The AP is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a computer readable storage medium, in which a computer program is stored, causes a computer to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1A is a diagram illustrating an example of coordinated beamforming (Co-BF) communication between a coordinating AP and a coordinated AP according to an embodiment of the present disclosure.

FIG. 1B is a diagram illustrating an example of Co-BF communication between a coordinating AP and a coordinated AP according to an embodiment of the present disclosure.

FIG. 1C is a block diagram of one or more AP devices and one or more non-AP station of communication in a communication network system according to an embodiment of the present disclosure.

FIG. 2 is a block diagram of one or more AP devices according to an embodiment of the present disclosure.

FIG. 3 is a block diagram of one or more AP devices according to an embodiment of the present disclosure.

FIG. 4A is a flowchart illustrating a method of coordinated operation performed by an access point (AP) device in a wireless local area network (WLAN) according to an embodiment of the present disclosure.

FIG. 4B is a flowchart illustrating a method of coordinated operation performed by an access point (AP) device in a wireless local area network (WLAN) according to an embodiment of the present disclosure.

FIG. 5 is a block diagram of an example of a computing device according to an embodiment of the present disclosure.

FIG. 6 is a block diagram of a communication system according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Some embodiments of the present disclosure provide an exemplary method by which two access point (AP) devices in a wireless local area network (WLAN) establish a mutual agreement for coordinated beamforming (COBF), enabling the AP devices to cooperatively manage downlink transmissions, mitigate interference across overlapping basic service sets (BSSs), and improve overall system efficiency and throughput.

In some embodiments of the present disclosure, the terms “coordinating access point (coordinating AP)” and “coordinated access point (coordinated AP)” follow the definitions provided in the description. In details, coordinated beamforming coordinating access point (Co-BF coordinating AP): A coordinating AP that initiates a coordinated beamforming (Co-BF) transmission with another AP. Coordinated beamforming coordinated access point (Co-BF coordinated AP): A coordinated AP that participates in a Co-BF transmission initiated by the Co-BF coordinating AP. Accordingly, in some embodiments of the present disclosure, the “initiating AP device” corresponds to the Co-BF coordinating AP, and the “responding AP device” corresponds to the Co-BF coordinated AP. In some embodiments of the present disclosure, “an initiating AP” corresponds to a coordinating AP, and “a responding AP” corresponds to a coordinated AP. These definitions are used interchangeably in some embodiments of the present disclosure to describe the functional relationship between multiple AP devices performing coordinated beamforming operations.

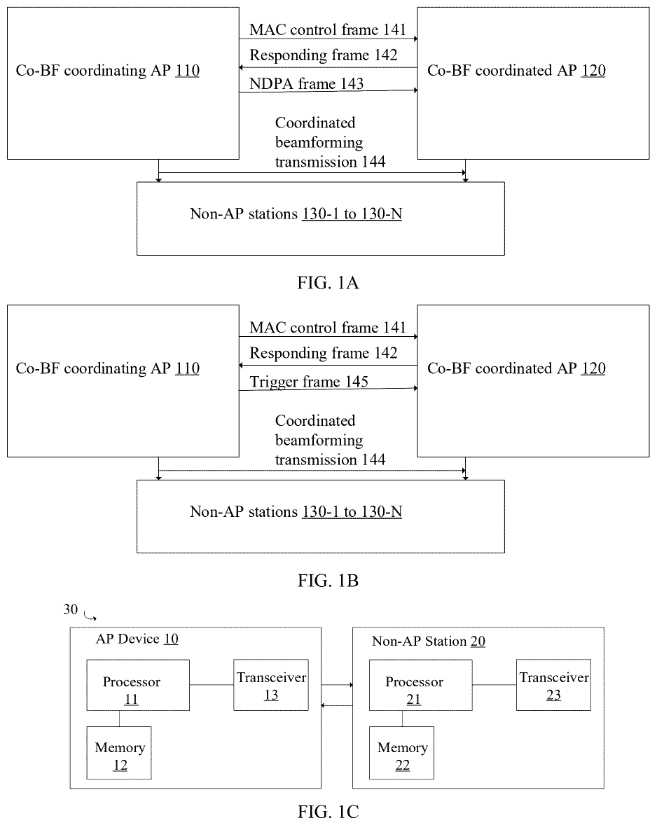

FIG. 1A illustrates an example of coordinated beamforming (Co-BF) communication between two access points (APs). In this embodiment, a Co-BF coordinating AP 110, also referred to as the initiating AP device, initiates a Co-BF operation by transmitting a medium access control (MAC) control frame 141 to a Co-BF coordinated AP 120, also referred to as the responding AP device. The Co-BF coordinated AP 120 may transmit a responding frame 142 to indicate participation in the coordinated beamforming procedure. The Co-BF coordinating AP 110 then transmits a null data packet announcement (NDPA) frame 143 to initiate a sounding operation for obtaining channel state information (CSI) from a plurality of non-AP stations 130-1 to 130-N. After acquiring CSI, both Co-BF coordinating AP 110 and the Co-BF coordinated AP 120 jointly perform a coordinated beamforming transmission 144 to the non-AP stations. FIG. 1A illustrates the logical relationship between the coordinating/coordinated APs and the corresponding initiating/responding APs as described in some embodiments. In details, in some embodiments, the “initiating AP device” corresponds to the Co-BF coordinating AP or a coordinating AP, and the “responding AP device” corresponds to the Co-BF coordinated AP or a coordinated AP.

FIG. 1B illustrates an example of coordinated beamforming (Co-BF) communication between two access points (APs). In this embodiment, a Co-BF coordinating AP 110, also referred to as the initiating AP device, initiates a Co-BF operation by transmitting a medium access control (MAC) control frame 141 to a Co-BF coordinated AP 120, also referred to as the responding AP device. The Co-BF coordinated AP 120 may transmit a responding frame 142 to indicate participation in the coordinated beamforming procedure. The Co-BF coordinating AP 110 then transmits a trigger frame 145 to initiate a sounding operation for obtaining channel state information (CSI) from a plurality of non-AP stations 130-1 to 130-N. After acquiring CSI, both Co-BF coordinating AP 110 and the Co-BF coordinated AP 120 jointly perform a coordinated beamforming transmission 144 to the non-AP stations. FIG. 1A and FIG. 1B illustrate the logical relationship between the coordinating/coordinated APs and the corresponding initiating/responding APs as described in some embodiments. In details, in some embodiments, the “initiating AP device” corresponds to the Co-BF coordinating AP or a coordinating AP, and the “responding AP device” corresponds to the Co-BF coordinated AP or a coordinated AP.

FIG. 1C illustrates that, in some embodiments, one or more AP devices 10 and non-AP stations 20 of communication in a communication network system 30 according to an embodiment of the present disclosure are provided. The communication network system 30 includes the one or more AP devices 10 and the non-AP stations 20. The one or more AP devices 10 may include a memory 12, a transceiver 13, and a processor 11 coupled to the memory 12 and the transceiver 13. The non-AP stations 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

In some embodiments, the transceiver 13 is configured to transmit, to at least one other AP device, coordination information or a negotiation request frame for multi-AP coordination (MAPC), and the processor 11 is configured to perform, based on a response from the at least one other AP device, a coordinated operation, wherein the coordinated operation includes at least one of: a coordinated beamforming (Co-BF), a coordinated spatial reuse (Co-SR), a coordinated time-division multiple access (Co-TDMA), or a coordinated ranging and positioning. This can solve issues in the prior art and other issues, provide unequal-bandwidth operation, low-overhead unified sounding, opportunistic path-loss measurement, TWT-assisted station availability, per-spatial-stream unequal modulation, failure-resilient procedures, and/or improved efficiency, flexibility, and reliability in wireless local area networks.

In some embodiments, the coordination information is carried by the negotiation request frame and is used to establish, update, or terminate a MAPC agreement between the AP device and the at least one other AP device. In some embodiments, the coordination information includes an indication of one or more MAPC schemes including the Co-BF, the Co-SR, or the Co-TDMA. In some embodiments, the coordination information includes an indication of a symmetrical or asymmetrical operation between the AP device and the at least one other AP device. In some embodiments, the processor 11 is configured to determine, during a MAPC negotiation, a role of a reference AP device and a follower AP device for a given MAPC scheme. In some embodiments, the follower AP device compensates synchronization information including carrier frequency offset (CFO) based on the reference AP device. In some embodiments, performing the coordinated operation includes aligning target wake time (TWT) schedules between the AP device and the at least one other AP device. In some embodiments, the TWT schedules are aligned on a per-MAPC-scheme basis. In some embodiments, the coordination information indicates whether the AP device operates as a TWT reference AP or a TWT follower AP for a given MAPC scheme. In some embodiments, the processor 11 is configured to negotiate TWT agreements with one or more associated stations such that the negotiated TWT schedules are consistent with a reference TWT schedule.

In some embodiments, performing the coordinated operation includes transmitting a null data packet announcement (NDPA) frame to initiate a unified sounding procedure. In some embodiments, the unified sounding procedure is used to measure at least one of: an in-BSS channel state information (CSI), a cross-BSS CSI, an in-BSS path loss, or a cross-BSS path loss. In some embodiments, the unified sounding procedure includes transmitting, by the AP device as an initiating AP device, a first null data packet announcement (NDPA) frame followed by a first null data packet (NDP) for in-BSS measurement, receiving, from one or more associated stations, measurement reports corresponding to at least one of in-BSS channel state information (CSI) or in-BSS path loss, transmitting, by the AP device, a second NDPA frame indicating a responding AP device, wherein the responding AP device transmits a second NDP for cross-BSS measurement, and receiving cross-BSS measurement reports corresponding to at least one of cross-BSS CSI or cross-BSS path loss. In some embodiments, the NDPA frame contains an indication of transmit power to support path-loss measurements. In some embodiments, performing the coordinated operation includes transmitting an initial control frame (ICF) to one or more stations associated with the AP device to determine station availability. In some embodiments, the AP device refrains from performing Co-BF data transmission during a transmission opportunity (TXOP) when no availability indication is received from the associated stations. In some embodiments, performing the coordinated operation includes transmitting, to the at least one other AP device, an invitation frame including an indication of a modulation and coding scheme (MCS) for each spatial stream. In some embodiments, the MCS indication supports unequal modulation across a spatial domain for coordinated beamforming. In some embodiments, the transceiver 13 receives, from the at least one other AP device, a rejection indication identifying at least one of a missing channel state information, or unavailability of stations. In some embodiments, performing the coordinated operation includes coordinated ranging between the AP device, the at least one other AP device, and a non-AP station. In some embodiments, the coordinated ranging includes transmitting trigger frames and null data packets to obtain time-of-arrival (ToA) and time-of-departure (ToD) measurements for estimating a position of the non-AP station based on measurements from multiple AP devices.

In some embodiments, the transceiver 13 is configured to receive, from another AP device, coordination information or a negotiation request frame for multi-AP coordination (MAPC) and transmit, to the another AP device, a response indicating acceptance, rejection, or configuration information for a coordinated operation including at least one of: a coordinated beamforming (Co-BF), a coordinated spatial reuse (Co-SR), a coordinated time-division multiple access (Co-TDMA), or a coordinated ranging and positioning. This can solve issues in the prior art and other issues, provide unequal-bandwidth operation, low-overhead unified sounding, opportunistic path-loss measurement, TWT-assisted station availability, per-spatial-stream unequal modulation, failure-resilient procedures, and/or improved efficiency, flexibility, and reliability in wireless local area networks.

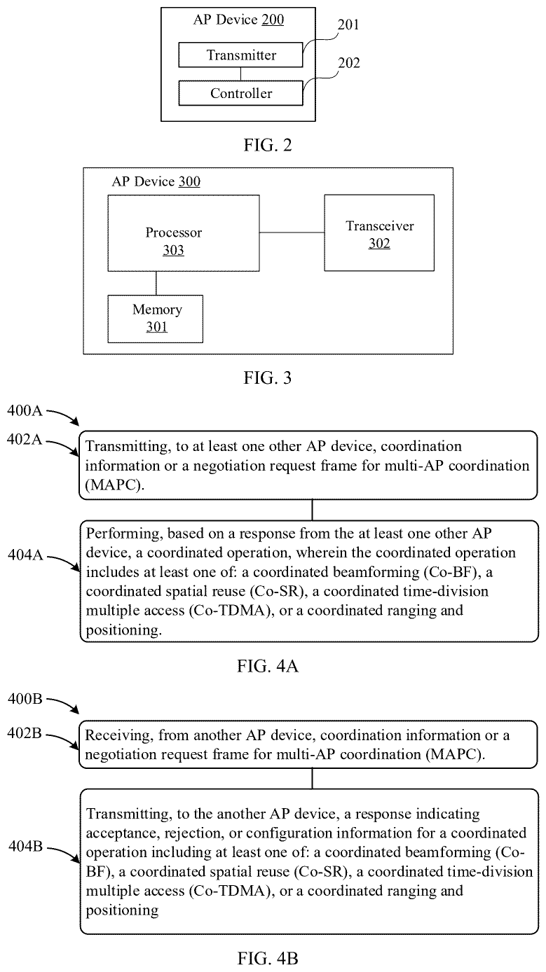

FIG. 2 illustrates an example of an AP device 200 according to an embodiment of the present application. The AP device 200 is configured to implement some embodiments of the disclosure. Some embodiments of the disclosure may be implemented into the AP device 200 using any suitably configured hardware and/or software. The AP device 200 includes a transmitter 201 and/or a controller 202. The transmitter 201 is configured to transmit, to at least one other AP device, coordination information or a negotiation request frame for multi-AP coordination (MAPC), and the controller 202 is configured to perform, based on a response from the at least one other AP device, a coordinated operation, wherein the coordinated operation includes at least one of: a coordinated beamforming (Co-BF), a coordinated spatial reuse (Co-SR), a coordinated time-division multiple access (Co-TDMA), or a coordinated ranging and positioning. This can solve issues in the prior art and other issues, provide unequal-bandwidth operation, low-overhead unified sounding, opportunistic path-loss measurement, TWT-assisted station availability, per-spatial-stream unequal modulation, failure-resilient procedures, and/or improved efficiency, flexibility, and reliability in wireless local area networks.

FIG. 3 illustrates an example of an AP device 300 according to an embodiment of the present disclosure. The AP device 300 is configured to implement some embodiments of the disclosure. Some embodiments of the disclosure may be implemented into the AP device 300 using any suitably configured hardware and/or software. The AP device 300 may include a memory 301, a transceiver 302, and a processor 303 coupled to the memory 301 and the transceiver 302. The processor 303 may be configured to implement proposed functions, procedures and/or methods described in this description. Layers of radio interface protocol may be implemented in the processor 303. The memory 301 is operatively coupled with the processor 303 and stores a variety of information to operate the processor 303. The transceiver 302 is operatively coupled with the processor 303, and the transceiver 302 transmits and/or receives a radio signal. The processor 303 may include application-specific integrated circuit (ASIC), other chipset, logic circuit and/or data processing device. The memory 301 may include read-only memory (ROM), random access memory (RAM), flash memory, memory card, storage medium and/or other storage device. The transceiver 302 may include baseband circuitry to process radio frequency signals. When the embodiments are implemented in software, the techniques described herein can be implemented with modules (e.g., procedures, functions, and so on) that perform the functions described herein. The modules can be stored in the memory 301 and executed by the processor 303. The memory 301 can be implemented within the processor 303 or external to the processor 303 in which case those can be communicatively coupled to the processor 303 via various means as is known in the art.

In some embodiments, the transceiver 302 is configured to transmit, to at least one other AP device, coordination information or a negotiation request frame for multi-AP coordination (MAPC), and the processor 303 is configured to perform, based on a response from the at least one other AP device, a coordinated operation, wherein the coordinated operation includes at least one of: a coordinated beamforming (Co-BF), a coordinated spatial reuse (Co-SR), a coordinated time-division multiple access (Co-TDMA), or a coordinated ranging and positioning. This can solve issues in the prior art and other issues, provide unequal-bandwidth operation, low-overhead unified sounding, opportunistic path-loss measurement, TWT-assisted station availability, per-spatial-stream unequal modulation, failure-resilient procedures, and/or improved efficiency, flexibility, and reliability in wireless local area networks.

FIG. 4A is an example of a method 400A of wireless communication performed by a AP device according to an embodiment of the present disclosure. The method 400A of wireless communication performed by the AP device is configured to implement some embodiments of the disclosure. Some embodiments of the disclosure may be implemented into the method 400A of wireless communication performed by the AP device using any suitably configured hardware and/or software. In some embodiments, the method 400A of wireless communication performed by the AP device includes: an operation 402A, transmitting, to at least one other AP device, coordination information or a negotiation request frame for multi-AP coordination (MAPC); and an operation 404A, performing, based on a response from the at least one other AP device, a coordinated operation, wherein the coordinated operation includes at least one of: a coordinated beamforming (Co-BF), a coordinated spatial reuse (Co-SR), a coordinated time-division multiple access (Co-TDMA), or a coordinated ranging and positioning. This can solve issues in the prior art and other issues, provide unequal-bandwidth operation, low-overhead unified sounding, opportunistic path-loss measurement, TWT-assisted station availability, per-spatial-stream unequal modulation, failure-resilient procedures, and/or improved efficiency, flexibility, and reliability in wireless local area networks.

FIG. 4B is an example of a method 400B of wireless communication performed by a AP device according to an embodiment of the present disclosure. The method 400B of wireless communication performed by the AP device is configured to implement some embodiments of the disclosure. Some embodiments of the disclosure may be implemented into the method 400B of wireless communication performed by the AP device using any suitably configured hardware and/or software. In some embodiments, the method 400B of wireless communication performed by the AP device includes: an operation 402B, receiving, from another AP device, coordination information or a negotiation request frame for multi-AP coordination (MAPC); and an operation 404B, transmitting, to the another AP device, a response indicating acceptance, rejection, or configuration information for a coordinated operation including at least one of: a coordinated beamforming (Co-BF), a coordinated spatial reuse (Co-SR), a coordinated time-division multiple access (Co-TDMA), or a coordinated ranging and positioning. This can solve issues in the prior art and other issues, provide unequal-bandwidth operation, low-overhead unified sounding, opportunistic path-loss measurement, TWT-assisted station availability, per-spatial-stream unequal modulation, failure-resilient procedures, and/or improved efficiency, flexibility, and reliability in wireless local area networks.

### Exemplary Technical Solutions

### Coordinated Ranging and Positioning:

Current wireless local area network (WLAN) positioning techniques, such as those specified in IEEE 802.11az, primarily adopt a client-centric ranging model in which a non-AP station initiates and coordinates fine timing measurements with multiple access point (AP) devices. Such approaches do not adequately support the use case where an AP device estimates the location of a client station, particularly in deployment scenarios where AP devices have fixed and known locations.

Moreover, in the IEEE 802.11az standard, a client station is required to perform fine timing measurement procedures sequentially with multiple AP devices to obtain sufficient measurements for position estimation. This sequential ranging process increases signaling overhead, prolongs measurement time, and reduces overall efficiency, especially when trilateration using three or more AP devices is required.

Some embodiments of the present disclosure provide a coordinated ranging and positioning method in which multiple AP devices perform synchronized ranging operations with a non-AP station. By enabling multi-AP coordination in the ranging procedure, bidirectional time-of-arrival (ToA) and time-of-departure (ToD) measurements can be obtained efficiently within a coordinated sequence, allowing an AP device to estimate the position of a client station using trilateration while reducing latency and signaling overhead.

### Co-BF/Co-SR Unified Framework:

Current multi-AP coordination (MAPC) techniques for coordinated beamforming (Co-BF) focus primarily on frame exchange sequences during channel sounding and data transmission phases. However, these techniques do not fully define negotiation, update, or termination procedures for MAPC agreements, nor do they provide sufficient mechanisms to handle dynamic availability of stations during a transmission opportunity (TXOP).

For example, in existing Co-BF solutions, if an AP device is unable to find available associated stations during a shared TXOP, the coordinated transmission may fail entirely. Such solutions lack robust mechanisms for station availability probing, rejection handling, and fallback behavior, thereby limiting the practical success rate of MAPC in dense or dynamic WLAN environments.

Some embodiments of the present disclosure provide unified methods for establishing, updating, and terminating MAPC agreements among multiple AP devices. By introducing explicit negotiation frames, acceptance and rejection indications, and availability-aware coordination procedures, the proposed solutions improve robustness and reliability of coordinated operations such as Co-BF and coordinated spatial reuse (Co-SR).

### TWT-Assisted Multi-AP Coordination:

Target Wake Time (TWT) mechanisms have been proposed to align wake schedules between AP devices; however, existing coordinated TWT proposals are not integrated with MAPC schemes such as Co-BF, Co-SR, or coordinated time-division multiple access (Co-TDMA). As a result, coordinated TWT has not been effectively utilized to improve station availability or coordination success in multi-AP operations.

Some embodiments of the present disclosure integrate TWT mechanisms with MAPC by aligning TWT schedules on a per-scheme basis. By designating reference and follower AP devices and negotiating aligned TWT service periods for participating stations, the proposed solutions increase the likelihood that AP devices can find available stations during shared TXOPs, thereby enhancing coordination efficiency and flexibility.

### Robust Data Transmission With Unequal Modulation:

Current coordinated beamforming data-transmission procedures rely on rigid frame exchange sequences in which the failure to receive a required response frame—such as due to missing channel state information (CSI) or station unavailability—may cause the entire transmission sequence to fail. These procedures therefore lack robustness and adaptability to real-world WLAN conditions.

Furthermore, existing Co-BF techniques typically support only per-user modulation and coding schemes (MCS), assuming equal modulation across spatial streams. Such designs do not accommodate unequal modulation across the spatial domain, limiting the ability to adapt transmission parameters to heterogeneous channel conditions among spatial streams.

Some embodiments of the present disclosure provide robust Co-BF data-transmission procedures that include explicit availability probing, rejection indication with failure reasons, and per-spatial-stream MCS signaling. By supporting unequal modulation (UEQM) and resilient frame exchange mechanisms, the proposed solutions enhance reliability, adaptability, and spectral efficiency of coordinated beamforming in WLANs.

### Exemplary Technical Solution 1

The IEEE 802.11az standard, commonly referred to as the next generation positioning (NGP) wireless local area network (WLAN) standard, enables stations (i.e., devices having the capability to use the IEEE 802.11 protocol, such as laptops, mobile phones, smart watches, etc.) to identify their positions relative to Wi-Fi access point (AP) devices (i.e., Wi-Fi modems connected to routers and allowing other Wi-Fi devices to access a network). The locations of Wi-Fi AP devices used for positioning are usually fixed, and therefore such AP devices are also referred to as anchors.

The localization method specified in the IEEE 802.11az standard is time-of-arrival-based (TOA-based) localization. For TOA-based localization, stations are required to synchronize with AP devices using the IEEE 802.11az protocol and estimate the time delay between the stations and the AP devices. Geometrically, the time delay between a station and each AP device defines a circle in a two-dimensional (2-D) plane or a sphere in a three-dimensional (3-D) space within which the station must lie. The position of the station is determined by the intersection of multiple such circles or spheres.

Multiple access point coordination (MAPC) in a WLAN refers to a set of schemes among multiple AP devices from overlapped basic service sets (OBSSs) to coordinate their transmissions for improved wireless media usage.

In some embodiments, MAPC is extended to support coordinated ranging and positioning with multiple AP devices. The invention may also be viewed as an extension of the trigger-based (TB) ranging procedure between one AP device and one station as specified in IEEE 802.11az, to coordinated ranging between multiple AP devices and one station. While the invention is applicable to any number of AP devices (at least two), the following description uses a three-AP scenario for simplicity, since the minimum number of AP devices required for trilateration-based position estimation is three.

Assume that three AP devices, AP0, AP1, and AP2, perform coordinated ranging. AP0 is the AP device that has knowledge of the locations of AP1 and AP2 and intends to locate an associated non-AP station.

The polling phase is the first phase of each polling/sounding/reporting triplet. In each polling phase instance, AP0 transmits a trigger frame to the station, AP1, and AP2 to check their availability. Once a response is received from each of these devices, AP0 proceeds to the measurement sounding phase. Otherwise, AP0 may transmit one or more additional trigger frames until responses are received from all three devices.

The measurement sounding phase begins after a short interframe space (SIFS) following the polling phase and is the second phase of each polling/sounding/reporting triplet. Measurement and reporting are performed according to the following steps:

AP0 transmits a trigger frame to AP1, AP2, and the station. The trigger frame allocates uplink resources to the station.

After a SIFS following reception of the trigger frame, the station transmits a null data packet (NDP). The station measures the time of departure (ToD) of the NDP, and all three AP devices measure the time of arrival (ToA) of the NDP.

After a SIFS following reception of the NDP from the station, AP0 transmits a null data packet announcement (NDPA) frame followed by an NDP. AP0 measures the ToD of the NDP. The NDPA frame contains an STA Info field specifying the station that will use the NDP, and the station measures the ToA of the NDP.

After a SIFS following transmission of the NDP, AP0 transmits a location measurement report (LMR) containing its measured ToA and ToD to the station.

After a SIFS following transmission of the LMR, AP0 transmits an NDPA frame containing an STA Info field specifying the station and a special STA Info field specifying AP1.

After a SIFS following reception of the NDPA from AP0, AP1 transmits an NDP and measures the ToD of the NDP. The station measures the ToA of the NDP.

After a SIFS following transmission of the NDP, AP1 transmits an LMR containing its measured ToA and ToD to AP0 and the station.

After a SIFS following reception of the LMR from AP1, AP0 transmits an NDPA frame containing an STA Info field specifying the station and a special STA Info field specifying AP2.

After a SIFS following reception of the NDPA from AP0, AP2 transmits an NDP and measures the ToD of the NDP. The station measures the ToA of the NDP.

After a SIFS following transmission of the NDP, AP2 transmits an LMR containing its measured ToA and ToD to AP0 and the station.

After a SIFS following reception of the LMR from AP2, AP0 transmits a trigger frame to the station soliciting its measurements. The station transmits an LMR containing its measured ToD and three ToA values to AP0.

After completion of the above steps, AP0 obtains bidirectional ToD and ToA measurements for the three paths between AP0 and the station, between AP1 and the station, and between AP2 and the station. Accordingly, AP0 can estimate the three distances between the station and the respective AP devices and perform trilateration-based position estimation to determine the location of the station.

In addition, since the station also possesses the corresponding ToD and ToA measurements, the station itself may estimate its position relative to the three AP devices, provided that the station has knowledge of the locations of the three AP devices.

The above measurement and reporting procedure can be readily extended to multiple non-AP stations, such that the AP devices may simultaneously estimate the positions of multiple stations.

Some embodiments provide a novel solution enabling an AP device to estimate the positions of client stations based on multi-AP coordinated ranging.

Some embodiments further enable a client station to estimate its position relative to multiple AP devices in a more efficient manner than the positioning procedure specified in the IEEE 802.11az standard.

The IEEE 802.11az standard provides time-of-arrival (ToA) based positioning in which a station estimates its location relative to fixed and known AP anchors, but it adopts a client-centric and typically sequential ranging model that incurs high signaling overhead, long latency, and limited efficiency, especially when an AP device intends to locate a station or when multiple APs and stations are involved. Some embodiments of the present disclosure extend multi-AP coordination (MAPC) to coordinated ranging and positioning, transforming the trigger-based ranging procedure defined in IEEE 802.11az from a one-AP-to-one-station model into a coordinated multi-AP-to-station procedure. In an exemplary configuration, an initiating AP coordinates polling, sounding, and reporting phases among multiple AP devices and a station to obtain bidirectional time-of-departure (ToD) and time-of-arrival (ToA) measurements for multiple links, enabling efficient trilateration-based position estimation at the AP and, optionally, at the station. By leveraging coordinated signaling among AP devices, the proposed approach significantly reduces ranging latency and signaling overhead, supports simultaneous positioning of multiple stations, and provides a scalable and efficient AP-centric positioning solution that improves upon the client-centric procedures specified in IEEE 802.11az.

### Exemplary Technical Solution 2

Multiple access point coordination (MAPC) in a wireless local area network (WLAN) refers to a set of schemes among multiple access point (AP) devices from overlapped basic service sets (BSSs) to coordinate their transmissions for improved wireless media usage. Coordinated beamforming (Co-BF) and coordinated spatial reuse (Co-SR) are two representative examples of MAPC.

Coordinated beamforming (Co-BF) is a technology that enables AP devices from overlapped BSSs to deploy multiple transmit antennas in a coordinated fashion to mitigate interference across the BSSs. For a given transmission opportunity (TXOP), the AP device that holds the TXOP shares the TXOP for Co-BF transmission with only one other AP device.

Coordinated spatial reuse (Co-SR) is a technology that enables more efficient wireless medium usage by allowing concurrent transmissions from multiple AP devices through transmit power control to suppress mutual interference between the transmissions.

Two AP devices may establish an MAPC agreement for both Co-BF and Co-SR. For each TXOP shared by the two AP devices for data transmission, either Co-BF or Co-SR may be applied. In both Co-BF and Co-SR, a sharing AP device refers to an AP device that shares its obtained TXOP with other AP devices for data transmission, and a shared AP device refers to an AP device that transmits data during the TXOP held by the sharing AP device.

Before starting data transmissions with Co-SR, the AP devices first establish an agreement on transmission configurations and obtain both in-BSS and cross-BSS path loss measurements from their associated stations, respectively. Before starting data transmissions with Co-BF, the AP devices likewise establish an agreement on transmission configurations and perform channel sounding operations to measure both in-BSS and cross-BSS channel state information (CSI).

The following procedure is designed for channel sounding of Co-BF.

Upon obtaining a TXOP, the initiating AP device (i.e., the AP device that initiates a sounding procedure) transmits an invitation frame to a responding AP device (i.e., the AP device that responds to a sounding invitation) to invite the responding AP device to participate in channel sounding for Co-BF during the TXOP.

A short interframe space (SIFS) after receiving the invitation frame from the initiating AP device, the responding AP device transmits a response frame to the initiating AP device to accept the invitation to participate in channel sounding during the TXOP and to indicate a transmit power of a null data packet (NDP) that it will transmit for cross-BSS sounding.

An SIFS after receiving the response frame from the responding AP device, the initiating AP device transmits a null data packet announcement (NDPA) frame followed by an NDP. The NDPA frame contains STA Info fields specifying associated stations that will measure in-BSS CSI for Co-BF and associated stations that will measure in-BSS path loss from the initiating AP device for Co-SR. Stations participating in either Co-BF or Co-SR measure both CSI and path loss. The NDPA frame further indicates the transmit power of the NDP transmitted by the initiating AP device.

An SIFS after transmitting the NDP, the initiating AP device transmits a trigger frame (e.g., a beamforming report poll) to its associated stations to solicit measurement reports.

An SIFS after receiving the trigger frame, the stations participating in Co-BF transmit in-BSS CSI measurements, and the stations participating in Co-SR transmit path loss measurements to the initiating AP device. Stations participating in both schemes report both measurements.

An SIFS after receiving the measurement report frames, the initiating AP device transmits an NDPA frame containing a special STA Info field specifying the responding AP device and STA Info fields specifying associated stations that will measure cross-BSS CSI for Co-BF and cross-BSS path loss for Co-SR. The NDPA frame also indicates the transmit power of the NDP to be transmitted by the responding AP device.

An SIFS after receiving the NDPA frame, the responding AP device transmits an NDP using the indicated transmit power. Stations participating in Co-BF measure cross-BSS CSI using the NDP, and stations participating in Co-SR measure cross-BSS path loss using the NDP and the indicated transmit power.

An SIFS after receiving the NDP, the initiating AP device transmits a trigger frame to its associated stations to solicit measurement reports.

An SIFS after receiving the trigger frame, the stations participating in Co-BF transmit cross-BSS CSI measurements, and the stations participating in Co-SR transmit cross-BSS path loss measurements to the responding AP device.

A similar procedure may be applied for stations associated with the responding AP device to measure in-BSS CSI, cross-BSS CSI, in-BSS path loss from the responding AP device, and cross-BSS path loss from the initiating AP device.

After completion of the sounding phase, either AP device may initiate a data transmission phase of Co-BF upon obtaining a TXOP and becoming the sharing AP device. To start data transmission with Co-BF, the sharing AP device transmits an invitation frame to the shared AP device offering one of the following options: a) participation in Co-BF during the TXOP; b) participation in Co-SR during the TXOP; or c) participation in either Co-BF or Co-SR during the TXOP.

The following procedure is designed for data transmission in either Co-BF or Co-SR.

Upon obtaining a TXOP, the sharing AP device transmits a control frame (e.g., an initial control frame (ICF)) to its associated stations having downlink traffic, to determine station availability.

An SIFS after receiving the control frame, an associated station may transmit a control reply frame (e.g., an initial control reply (ICR)) indicating its availability.

If no response is received from associated stations, the sharing AP device does not proceed with Co-BF or Co-SR. Otherwise, an SIFS after receiving station responses, the sharing AP device transmits an invitation frame to the shared AP device offering participation in Co-BF, Co-SR, or either.

An SIFS after receiving the invitation frame, the shared AP device transmits a control frame to its associated stations to determine station availability.

An SIFS after receiving the control frame, an associated station may transmit a control reply frame indicating availability.

If no response is received, the shared AP device transmits a response frame declining participation. Otherwise, an SIFS after receiving station responses, the shared AP device transmits a response frame accepting participation in Co-BF, Co-SR, or selecting between the two.

An SIFS after receiving the response frame, the sharing AP device transmits a trigger frame to initiate downlink PPDU transmission.

Some embodiments of the present disclosure provide a unified framework for Co-BF and Co-SR, including a novel channel sounding and measurement procedure and a robust data transmission procedure. The proposed solution significantly improves the success rate and robustness of MAPC operations. The proposed solution provides a novel and efficient mechanism for path loss measurement in Co-SR without introducing additional complexity or excessive airtime overhead.

Some embodiments of the present disclosure provide a unified multiple-AP coordination (MAPC) framework that integrates coordinated beamforming (Co-BF) and coordinated spatial reuse (Co-SR) through common negotiation, measurement, and data-transmission procedures, including a unified channel sounding mechanism for obtaining in-BSS and cross-BSS CSI and path-loss information, explicit sharing-AP and shared-AP role definition, and robust availability probing with acceptance and rejection handling, thereby improving coordination reliability, reducing procedural fragility, lowering signaling and airtime overhead, enhancing spectral efficiency, and significantly increasing the overall success rate and practicality of MAPC operations in dense WLAN deployments.

### Exemplary Technical Solution 3

Multiple access point coordination (MAPC) in a wireless local area network (WLAN) refers to a set of schemes among multiple access point (AP) devices from overlapped basic service sets (OBSSs) to coordinate their transmissions for improved wireless media usage. Typical MAPC schemes include coordinated beamforming (Co-BF), coordinated spatial reuse (Co-SR), and coordinated time-division multiple access (Co-TDMA).

Co-BF is a technology that enables AP devices from OBSSs to deploy multiple transmit antennas in a coordinated fashion to mitigate interference across basic service sets (BSSs). For a given transmission opportunity (TXOP), the AP device that holds the TXOP shares the TXOP for Co-BF transmission with only one other AP device.

Co-SR is a technology that allows more efficient wireless medium usage by enabling concurrent transmissions from multiple AP devices through transmit power control to suppress interference between the transmissions.

Co-TDMA is a procedure that enables an AP device that has obtained a TXOP to share a time portion of the TXOP with a set of AP devices.

The target wake time (TWT) feature is specified in the IEEE 802.11ax/be standard. With the TWT mechanism, stations may agree with an AP device on a common wake scheduling, allowing stations to wake up only when required, thereby minimizing energy consumption and contention within a basic service set (BSS), that is, the wireless local area network formed by the AP device and its associated stations. Two key concepts are useful for understanding TWT operation. A TWT session, or service period (SP), refers to the period during which a station is awake to transmit or receive data. A TWT agreement is the arrangement established between an AP device and a station through negotiation, which defines parameters of one or more TWT SPs, such as the time(s) at which the station wakes up. One TWT agreement may allow a station to participate in multiple periodic TWT SPs. The IEEE 802.11 amendment does not specify criteria for selecting stations for a TWT session or how TWT schedules are determined, and such decisions therefore depend on implementation.

Two AP devices under an MAPC agreement may align at least a portion of their TWT schedules. Such alignment provides two main benefits. First, the AP devices may schedule their associated stations to wake up during the aligned SPs, thereby increasing the likelihood that the AP devices can find available stations for MAPC operations during TXOPs obtained by the AP devices. Second, when an AP device participates in MAPC during a given TXOP and searches among its associated stations for MAPC candidates, the AP device may optimize the selection of a subset of stations from multiple possible subsets according to various criteria.

Because multiple MAPC schemes (for example, Co-BF, Co-SR, and Co-TDMA) may be agreed upon between a pair of AP devices, TWT alignment is performed on a per-scheme basis. For example, if two AP devices establish MAPC agreements for Co-BF, Co-SR, and Co-TDMA, a separate aligned TWT schedule may be defined for each scheme, and the aligned TWT schedules for different schemes may be identical or different.

For a given MAPC scheme, one of the two AP devices under a pairwise MAPC agreement serves as a TWT reference AP, while the other serves as a TWT follower AP. For instance, if two AP devices establish MAPC agreements for both Co-BF and Co-SR, one AP device may serve as the TWT reference AP for Co-BF and as the TWT follower AP for Co-SR, particularly when the reference TWT schedules for the two schemes differ.

The roles of TWT reference AP and TWT follower AP are determined during the MAPC negotiation procedure. An MAPC-requesting AP device may initiate negotiation with one or more AP devices by transmitting individually addressed management frames to establish MAPC agreements. In such a management frame, the initiating AP device may request that a responding AP device serve as a TWT reference AP or as a TWT follower AP on a per-scheme basis. When the responding AP device is requested to serve as a TWT follower AP, the initiating AP device indicates its own TWT schedule, such as the start time of a next SP, the interval between SPs, and the duration of each SP, as the reference TWT schedule. After receiving the management frame, the responding AP device transmits a management frame, such as a response frame, to the initiating AP device indicating, for each MAPC scheme, one of the following: (1) declining the request; (2) accepting the role of TWT follower AP; or (3) accepting the role of TWT reference AP and indicating a reference TWT schedule, including parameters such as SP start time, interval, and duration.

Once determined, the roles of TWT reference AP and TWT follower AP remain unchanged for the duration of the MAPC agreement for the corresponding scheme. After a reference TWT schedule for a given MAPC scheme is agreed upon, each of the two AP devices negotiates TWT agreements with its associated stations participating in the MAPC scheme such that the resulting station-level TWT schedules are aligned with the reference TWT schedule.

Either AP device may terminate TWT schedule alignment for a specific MAPC scheme by transmitting a management frame indicating termination to its partner AP device, even if the MAPC agreement for that scheme remains in effect.

Some embodiments propose a solution that enables AP devices participating in multi-AP coordination to align their target wake time (TWT) schedules. The solution is novel in that it combines the existing TWT feature with the emerging MAPC framework. The technical benefits include: AP devices can schedule their associated stations to wake up during aligned TWT service periods, increasing the likelihood of finding available stations for MAPC operations during TXOPs obtained by the AP devices; and when an AP device participates in MAPC during a given TXOP and searches its associated stations for MAPC candidates, the AP device can optimize selection of a subset of stations from multiple possible subsets based on various criteria.

Some embodiments of the present disclosure provide a per-scheme target wake time (TWT) alignment mechanism for multi-AP coordination (MAPC), in which access point (AP) devices negotiating coordinated beamforming (Co-BF), coordinated spatial reuse (Co-SR), and/or coordinated time-division multiple access (Co-TDMA) assign reference-AP and follower-AP roles and align TWT schedules accordingly, enabling associated stations to wake during coordinated service periods, increasing the likelihood of station availability during shared transmission opportunities, reducing contention and energy consumption, and providing greater flexibility and efficiency in selecting station subsets for coordinated transmissions across diverse WLAN deployment scenarios.

### Exemplary Technical Solution 4

Multiple access point coordination (MAPC) in a wireless local area network (WLAN) refers to a set of schemes among multiple access point (AP) devices from overlapped basic service sets (OBSSs) to coordinate their transmissions for improved wireless media usage. Coordinated beamforming (Co-BF) is one of the MAPC schemes. Co-BF enables AP devices from OBSSs to deploy multiple transmit antennas in a coordinated manner so as to mitigate interference across basic service sets (BSSs). For a given transmission opportunity (TXOP), an AP device that holds the TXOP shares the TXOP for Co-BF data transmission with only one other AP device.

In Co-BF, a sharing AP device refers to an AP device that shares its obtained TXOP with another AP device for data transmission, while a shared AP device refers to an AP device that transmits data during the TXOP held by the sharing AP device. Prior to Co-BF data transmission, channel sounding phases are performed so that both the sharing AP device and the shared AP device can obtain channel state information (CSI) required to derive precoding matrices for coordinated data transmission.

Unequal modulation (UEQM) is a re-emerging technology in which different spatial streams are modulated using different modulation schemes, such as quadrature phase shift keying (QPSK), 64-quadrature amplitude modulation (64-QAM), or 256-quadrature amplitude modulation (256-QAM), thereby enabling flexible adaptation to heterogeneous channel conditions in the spatial domain. UEQM may be applied to data transmission with Co-BF.

The following procedure is designed for Co-BF data transmission.

Upon obtaining a TXOP, the sharing AP device transmits a control frame, such as an initial control frame (ICF), to a set of its associated stations for which downlink traffic is pending. The primary purpose of the control frame is to check the availability of the stations.

After a short interframe space (SIFS) following reception of the control frame, an associated station may transmit a control frame, such as an initial control reply (ICR), to the sharing AP device to indicate its availability.

If the sharing AP device does not receive any response from its associated stations, the sharing AP device does not proceed with Co-BF data transmission during the TXOP. Otherwise, the sharing AP device selects one or more responding stations for Co-BF. After an SIFS following reception of the response frame(s) from the stations, the sharing AP device transmits an invitation frame to the shared AP device to invite participation in Co-BF during the TXOP. The invitation frame includes, but is not limited to, identifications of the selected stations (for example, association identifiers) and a modulation and coding scheme (MCS) for each spatial stream to be used by the sharing AP device in Co-BF downlink data transmission.

After an SIFS following reception of the invitation frame from the sharing AP device, the shared AP device proceeds according to one of the following cases:
a. If the shared AP device has not received CSI from the stations indicated in the invitation frame during previous channel sounding phases, the shared AP device transmits a response frame to the sharing AP device to decline participation in Co-BF during the TXOP and indicates that the rejection reason is missing cross-BSS CSI.
b. Otherwise, the shared AP device transmits a control frame, such as an ICF, to a set of its associated stations for which downlink traffic is pending, in order to check station availability.

After an SIFS following reception of the control frame from the shared AP device, an associated station may transmit a control frame, such as an ICR, to the shared AP device indicating its availability.

The shared AP device then proceeds according to one of the following cases:
Case 1: If the shared AP device does not receive any response from its associated stations, the shared AP device transmits a response frame to the sharing AP device to decline participation in Co-BF and indicates that the rejection reason is unavailability of stations.
Case 2: After an SIFS following reception of response frame(s) from one or more associated stations, the shared AP device transmits a response frame to the sharing AP device indicating acceptance of participation in Co-BF during the TXOP. The response frame includes, but is not limited to, identifications of selected stations and an MCS for each spatial stream to be used by the shared AP device in Co-BF downlink data transmission.

After an SIFS following reception of the response frame from the shared AP device indicating acceptance of participation in Co-BF, the sharing AP device transmits a trigger frame to trigger downlink transmission of a physical layer protocol data unit (PPDU) by the sharing AP device and the shared AP device.

Some embodiments propose a data transmission procedure for coordinated beamforming. The proposed solution includes the following innovative and beneficial aspects. The data transmission procedure is robust in that potential transmission failures are avoided even when a response frame is not received from an intended station, for example due to station unavailability. The procedure includes explicit mechanisms for handling failure to receive CSI measurement reports, thereby preventing erroneous Co-BF operation when required cross-BSS CSI is unavailable. The procedure accommodates per-spatial-stream MCS indication in frame exchanges between AP devices, thereby supporting both equal modulation and unequal modulation across the spatial domain for each AP device and enabling UEQM in Co-BF data transmission.

Some embodiments of the present disclosure provide a robust coordinated beamforming (Co-BF) data-transmission procedure within a multi-AP coordination (MAPC) framework, in which explicit availability probing, acceptance and rejection signaling, and missing-CSI handling are incorporated to prevent fragile transmission sequences and avoid Co-BF failures, while per-spatial-stream modulation and coding scheme (MCS) indication enables both equal and unequal modulation across spatial streams, thereby supporting unequal modulation (UEQM) and improving flexibility, reliability, and overall performance of coordinated downlink transmission in overlapped WLAN deployments.

Commercial interests for some embodiments are as follows. 1. Solve issues in the prior art and other issues. 2. Provide unequal-bandwidth operation, low-overhead unified sounding, opportunistic path-loss measurement, TWT-assisted station availability, per-spatial-stream unequal modulation, failure-resilient procedures, and/or improved efficiency, flexibility, and reliability in wireless local area networks. 3. Provide a good communication performance. 4. Provide high reliability. Some embodiments of the present disclosure can be used in many applications. Some embodiments of the present disclosure are used by chipset vendors, video system development vendors, automakers including cars, trains, trucks, buses, bicycles, moto-bikes, helmets, and etc., drones (unmanned aerial vehicles), smartphone makers, communication devices for public safety use, AR/VR/MR device maker for example gaming, conference/seminar, education purposes. Some embodiments of the present disclosure are a combination of “techniques/processes” that can be adopted in video standards to create an end product. Some embodiments of the present disclosure propose technical mechanisms. The at least one proposed solution, method, system, and apparatus of some embodiments of the present disclosure may be used for current and/or new/future standards regarding communication systems such as a UE, a base station, and/or a communication system. Compatible products follow at least one proposed solution, method, system, and apparatus of some embodiments of the present disclosure. The proposed solution, method, system, and apparatus are widely used in a UE, a base station, and/or a communication system. With the implementation of the at least one proposed solution, method, system, and apparatus of some embodiments of the present disclosure, at least one modification to methods and apparatus of wireless communication are considered for standardizing.

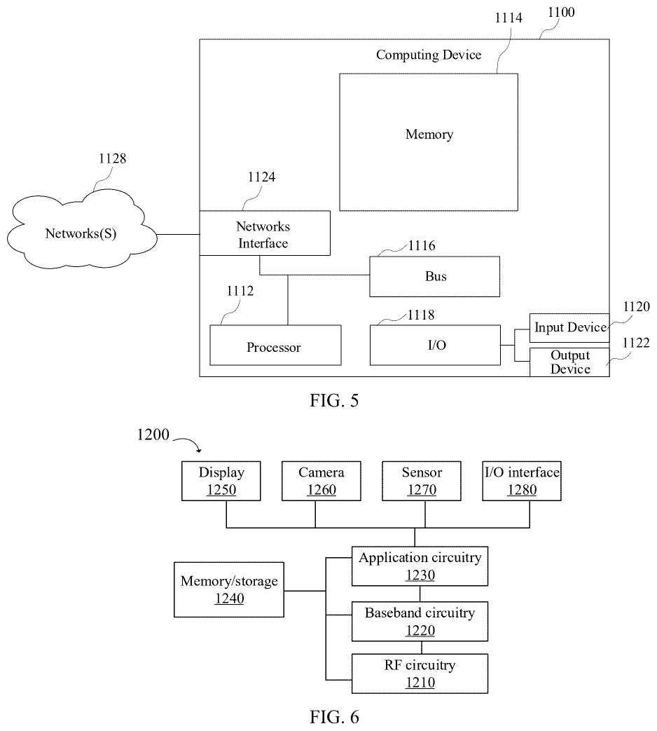

FIG. 5 is an example of a computing device 1100 according to an embodiment of the present disclosure. Any suitable computing device can be used for performing the operations described herein. For example, FIG. 5 illustrates an example of the computing device 1100 that can implement some embodiments of FIG. 1A to FIG. 4B using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a computer-readable medium storing instructions that, when executed by the processor 1112, cause the processor to perform the operations described herein.

The memory 1114 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to some embodiments of FIG. 1A to FIG. 4B. The program code may be resident in the memory 1114 or any suitable computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 6 is a block diagram of an example of a communication system 1200 according to an embodiment of the present disclosure. Embodiments described herein may be implemented into the communication system 1200 using any suitably configured hardware and/or software. FIG. 6 illustrates the communication system 1200 including a radio frequency (RF) circuitry 1210, a baseband circuitry 1220, an application circuitry 1230, a memory/storage 1240, a display 1250, a camera 1260, a sensor 1270, and an input/output (I/O) interface 1280, coupled with each other at least as illustrated.

The application circuitry 1230 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system. The communication system 1200 can execute program code that configures the application circuitry 1230 to perform one or more of the operations described above with respect to some embodiments of FIG. 1A to FIG. 4B. The program code may be resident in the application circuitry 1230 or any suitable computer-readable medium and may be executed by the application circuitry 1230 or any other suitable processor.

The baseband circuitry 1220 may include circuitry such as, but not limited to, one or more single-core or multi-core processors. The processors may include a baseband processor. The baseband circuitry may handle various radio control functions that may enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 1220 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 1210 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1210 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to some embodiments of FIG. 1A to FIG. 4B may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 1240 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 1280 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 1270 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 1250 may include a display, such as a liquid crystal display and a touch screen display. In various embodiments, the communication system 1200 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and operations described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the operations disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of coordinated operation performed by an access point (AP) device in a wireless local area network (WLAN), comprising:
transmitting, to at least one other AP device, coordination information or a negotiation request frame for multi-AP coordination (MAPC); and
performing, based on a response from the at least one other AP device, a coordinated operation, wherein the coordinated operation comprises at least one of:
a coordinated beamforming (Co-BF),
a coordinated spatial reuse (Co-SR),
a coordinated time-division multiple access (Co-TDMA), or
a coordinated ranging and positioning.

2. The method of claim 1, wherein the coordination information is carried by the negotiation request frame and is used to establish, update, or terminate a MAPC agreement between the AP device and the at least one other AP device.

3. The method of claim 1, wherein the coordination information comprises an indication of one or more MAPC schemes including the Co-BF, the Co-SR, or the Co-TDMA.

4. The method of claim 1, wherein the coordination information comprises an indication of a symmetrical or asymmetrical operation between the AP device and the at least one other AP device.

5. The method of claim 1, further comprising determining, during a MAPC negotiation, a role of a reference AP device and a follower AP device for a given MAPC scheme.

6. The method of claim 5, wherein the follower AP device compensates synchronization information including carrier frequency offset (CFO) based on the reference AP device.

7. The method of claim 1, wherein performing the coordinated operation comprises aligning target wake time (TWT) schedules between the AP device and the at least one other AP device.

8. The method of claim 7, wherein the TWT schedules are aligned on a per-MAPC-scheme basis.

9. The method of claim 7, wherein the coordination information indicates whether the AP device operates as a TWT reference AP or a TWT follower AP for a given MAPC scheme.

10. The method of claim 7, further comprising negotiating, by the AP device, TWT agreements with one or more associated stations such that the negotiated TWT schedules are consistent with a reference TWT schedule.

11. The method of claim 1, wherein performing the coordinated operation comprises transmitting a null data packet announcement (NDPA) frame to initiate a unified sounding procedure.

12. The method of claim 11, wherein the unified sounding procedure comprises:
transmitting, by the AP device as an initiating AP device, a first null data packet announcement (NDPA) frame followed by a first null data packet (NDP) for in-BSS measurement;
receiving, from one or more associated stations, measurement reports corresponding to at least one of in-BSS channel state information (CSI) or in-BSS path loss;
transmitting, by the AP device, a second NDPA frame indicating a responding AP device, wherein the responding AP device transmits a second NDP for cross-BSS measurement; and
receiving cross-BSS measurement reports corresponding to at least one of cross-BSS CSI or cross-BSS path loss.

13. The method of claim 11, wherein the NDPA frame contains an indication of transmit power to support path-loss measurements.

14. The method of claim 1, wherein performing the coordinated operation comprises transmitting an initial control frame (ICF) to one or more stations associated with the AP device to determine station availability.

15. The method of claim 14, wherein the AP device refrains from performing Co-BF data transmission during a transmission opportunity (TXOP) when no availability indication is received from the associated stations.

16. The method of claim 1, wherein performing the coordinated operation comprises transmitting, to the at least one other AP device, an invitation frame including an indication of a modulation and coding scheme (MCS) for each spatial stream, wherein the MCS indication supports unequal modulation across a spatial domain for coordinated beamforming.

17. The method of claim 1, wherein the AP device receives, from the at least one other AP device, a rejection indication identifying at least one of:
a missing channel state information, or
unavailability of stations.

18. The method of claim 1, wherein performing the coordinated operation comprises coordinated ranging between the AP device, the at least one other AP device, and a non-AP station, wherein the coordinated ranging comprises transmitting trigger frames and null data packets to obtain time-of-arrival (ToA) and time-of-departure (ToD) measurements for estimating a position of the non-AP station based on measurements from multiple AP devices.

19. A method of coordinated operation performed by an access point (AP) device, comprising:
receiving, from another AP device, coordination information or a negotiation request frame for multi-AP coordination (MAPC); and
transmitting, to the another AP device, a response indicating acceptance, rejection, or configuration information for a coordinated operation including at least one of: a coordinated beamforming (Co-BF), a coordinated spatial reuse (Co-SR), a coordinated time-division multiple access (Co-TDMA), or a coordinated ranging and positioning.

20. An AP device, comprising:
a memory;
a transceiver; and
a processor coupled to the memory and the transceiver;
wherein the transceiver is configured to transmit coordination information or a negotiation request frame for multi-AP coordination (MAPC); and
wherein the processor is configured to perform, based on a response from at least one other AP device, a coordinated operation comprising at least one of: a coordinated beamforming (Co-BF), a coordinated spatial reuse (Co-SR), a coordinated time-division multiple access (Co-TDMA), or a coordinated ranging and positioning.
